(19) United States
(12) Patent Application Publication
(10) Pub. No.: US 2013/0061139 A1
(43) Pub. Date: Mar. 7, 2013

(54) SERVER-BASED SPELL CHECKING ON A USER DEVICE

(71) Applicants: Ziga Mahkovec, San Francisco, CA (US); Linus M. Upson, Woodside, CA (US); Hironori Bono, Tokyo (JP); Yew Jin Lim, Cupertino, CA (US)

(72) Inventors: Ziga Mahkovec, San Francisco, CA (US); Linus M. Upson, Woodside, CA (US); Hironori Bono, Tokyo (JP); Yew Jin Lim, Cupertino, CA (US)

(73) Assignee: Google Inc.

(21) Appl. No.: 13/224,187

(22) Filed: Sep. 1, 2011

(51) Int. Cl. G06F 17/21; G06F 15/16

(52) U.S. Cl. 715/257

(57) ABSTRACT

Methods, systems, and apparatus, including computer programs encoded on a computer storage medium, for server-based spell check. One aspect of the subject matter described in this specification can be embodied in methods performed by a user device. The methods include the actions of receiving user input text; identifying a candidate term for spelling correction from the received text, the candidate term including a term designated as a misspelled term by a local spell checker, the local spell checker executing on the user device; sending the candidate term to a remote spell checker, the remote spell checker executing on a server that is connected to the user device through a communications network; receiving, from the remote spell checker, a spelling correction suggestion for the candidate term; and providing the spelling correction suggestion for display on the user device.

### BACKGROUND

This specification relates to spell checking text.

A spell checker aims to flag textual terms that may be spelled incorrectly. A conventional spell checker generally includes a dictionary and routines for comparing input text with terms in the dictionary. When a match between the input text and the terms in the dictionary cannot be found, the spell checker can flag the input text, and may provide a spelling suggestion. The dictionary is typically stored at a user device, for example, on a memory device that is part of a personal computer, smart phone, or tablet computer, and the spell check is performed locally at the user device.

A search query spell checker can perform spell checking remotely. When a user enters text as a search query at a user device, a query spell checker located remotely from the user device, e.g., one co-located with, or implemented as part of, a search engine, can spell check the user-entered text. A query spell checker can be based on an n-gram language model and a noisy channel model. The language model and noisy channel model can be generated from a collection of anonymized user queries received over time. Based on the language model and the noisy channel model, the query spell checker can perform a spell check on the search query, which typically contains no more than five or six words. The query spell checker can provide spelling suggestions resulting from the spell check to the user device for display in a response to the search query, in the form of query suggestions, for example.

### SUMMARY

This specification describes technologies relating to text spell checking performed by a server remote from user device.

In general, one aspect of the subject matter described in this specification can be embodied in methods performed by a server. The methods include the actions of receiving a request to spell check text; dividing the text into multiple segments, each segment including no more than a predetermined number of terms; providing each segment to a spell checker programmed to spell check an input including no more than the predetermined number of terms; receiving, from the spell checker, one or more spelling correction suggestions, each spelling correction suggestion corresponding to a term in a segment, the term being designated as misspelled by the spell checker; and assembling the received one or more spelling correction suggestions into a response to the request to spell check the text. Another aspect of the subject matter described in this specification can be embodied in methods performed by a user device. The methods include the actions of receiving user input text; identifying a candidate term for spelling correction from the received text, the candidate term including a term designated as a misspelled term by a local spell checker, the local spell checker executing on the user device; sending the candidate term to a remote spell checker, the remote spell checker executing on a server that is connected to the user device through a communications network; receiving, from the remote spell checker, a spelling correction suggestion for the candidate term; and providing the spelling correction suggestion for display on the user device.

Other embodiments of this aspect include corresponding systems, apparatus, and computer program products.

Particular embodiments of the subject matter described in this specification can be implemented to realize one or more of the following advantages. Spell checking can be performed based on a fixed dictionary as well as based on data reflecting customary and popular usage. Popular usage of a word can change frequently. The techniques described in this specification allow a spell checker to dynamically adapt to changes in how people spell or use a word.

Spell checking can be performed on text in multiple languages, for example, on a sentence or phrase that contains both English and Spanish words.

Spell checking a term can be performed based on a context of the term, in addition to the term itself. In some implementations, a system can use words before or after a term to determine whether a word is correctly spelled. For example, when spell checking a term “Lear,” a system can designate the term as correctly spelled when the term appears in “King Lear,” but designate the term as incorrectly spelled when the term appears in “Princess Lear.” In the latter case, the system can provide a term “Leia” as a spelling correction suggestion.

Spell checking can be customized automatically. The system can record user-specific terms (e.g., a name in a user's contact list) if the user opts into the system and allows the system to use the user's personal information to spell check the user's text. The system can then, without requiring the user to add the term to a customized dictionary, avoid flagging the user-specific term (e.g., a last name “Teh” in the contact list) as misspelled.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example system for server-based spell checking.

FIG. 2 is a block diagram illustrating an example user device configured for server-based spell checking.

FIG. 3 is a block diagram illustrating an example server for server-based spell checking.

FIG. 4 is a diagram illustrating example segmenting techniques of server-based spell checking.

FIG. 5A-5C are illustrations of example user interfaces of user-side application programs for server-based spell checking.

FIG. 6 is a flowchart illustrating an example process performed by a software component of a server for server-based spell checking.

FIG. 7 is a flowchart illustrating an example process performed by a software component of a user device for server-based spell checking.

Like reference numbers and designations in the various drawings indicate like elements.

### DETAILED DESCRIPTION

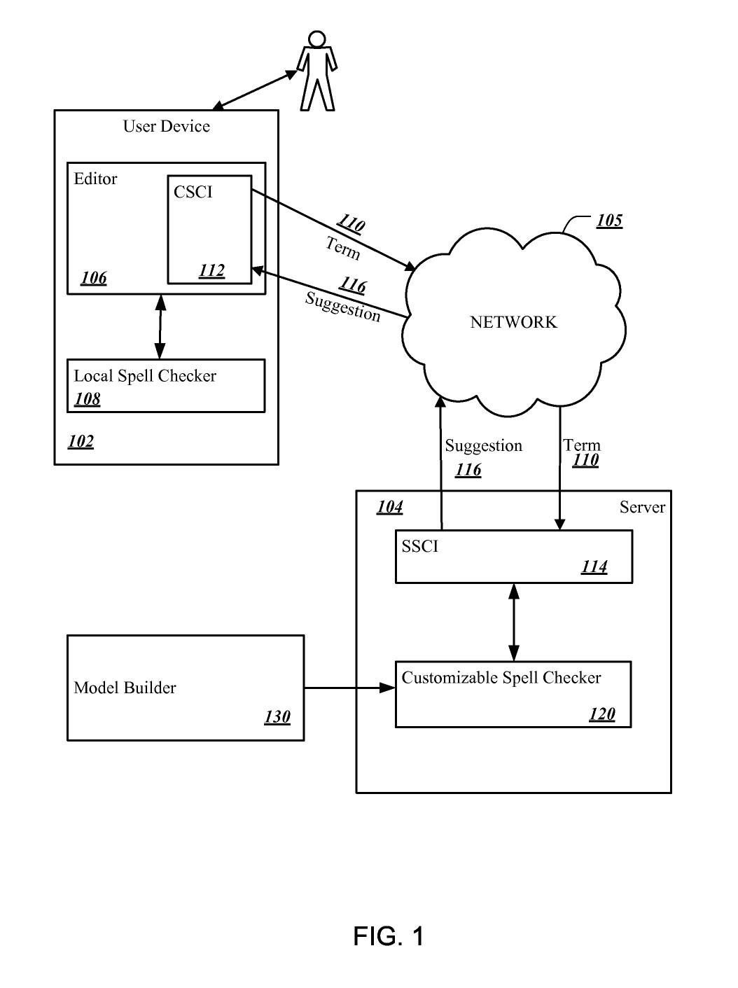

FIG. 1 is a block diagram illustrating an example system for server-based spell checking The system can include a user device 102 and a server 104. The user device 102 and server 104 can interact over a data communications network 105.

The user device 102 can be any kind of personal computing device, e.g., a personal computer, smart phone, or tablet computer. The user device 102 is programmed to perform a two-tiered spell checking on text input, first locally, then remotely. The user device 102 includes a local text editor 106 and a local spell checker 108. The text editor 106 is an application program configured to receive text input from a text edit area. The text editor 106 is configured to provide the received text input to the local spell checker 108 for spell checking.

The local spell checker 108 includes a program module that spell checks the text input using a local dictionary. When the local spell checker 108 identifies, based on the local dictionary, a term 110 in the input text that appears to be spelled incorrectly, the local spell checker 108 sends a notification to the text editor 106. Upon receiving the notification, the text editor 106 can mark the term 110 in the text edit area, for example, by highlighting, underlining, or changing a display color of the term, to indicate it may be misspelled.

The text editor 106 can automatically determine that the term 110 requires further spell checking, or receive user input (e.g., a mouse click on the marked term 110) that indicates the term needs further spell checking. Upon the automatic determination or upon receiving the input, the text editor 106 sends, in a request, the term 110 to the server 104 through the communications network 105 using a client-side spell check interface (CSCI) 112. The CSCI 112 is a software program that operates in communication with the text editor 106 and that is programmed to perform text selection operations and communication operations. Examples of the CSCI 112 include stand-alone programs, plugins to a word processing application program, or a JavaScript™ component that executes in a browser that renders a text editing box. The text selection operations include selecting additional text to send to the server 104 to provide a context for the term 110. The communication operations include sending the request including term 110 and the additional text to the server 104 and processing information returned from the server 104 in response to the request.

The server 104 includes one or more computers programmed to perform functions of server-based spell checking The server 104 can receive from the user device 102 text having one or more terms. The server 104 is programmed to divide the text into multiple segments, if the text includes more than one term. The server 104 can perform spell check on a segment that includes term 110.

The server 104 includes a server-side spell check interface (SSCI) 114. The SSCI 114 is a software component of the server 104 programmed to communicate with the CSCI 112 of user device 102 through communications network 105. The SSCI 114 is programmed to perform operations of receiving the term 110, and optional text in addition to the term 110, if any, from the user device 102. In addition, the SSCI 114 is programmed to perform operations of providing spelling correction suggestions 116 to the user device 102 in response to the request from the CSCI 112.

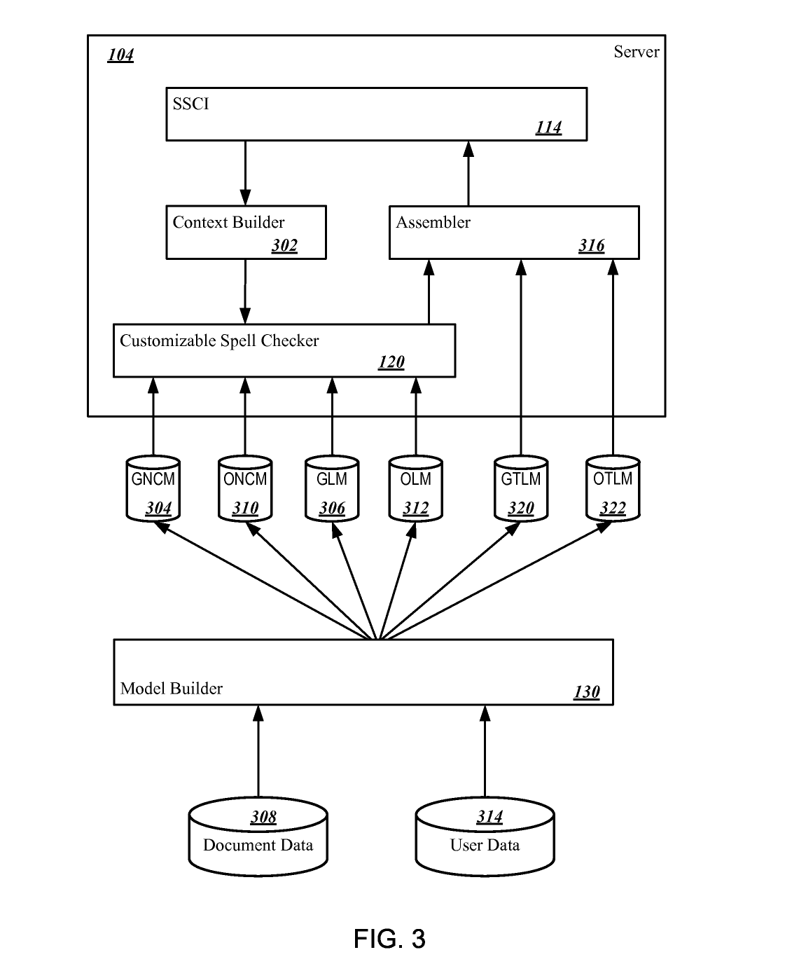

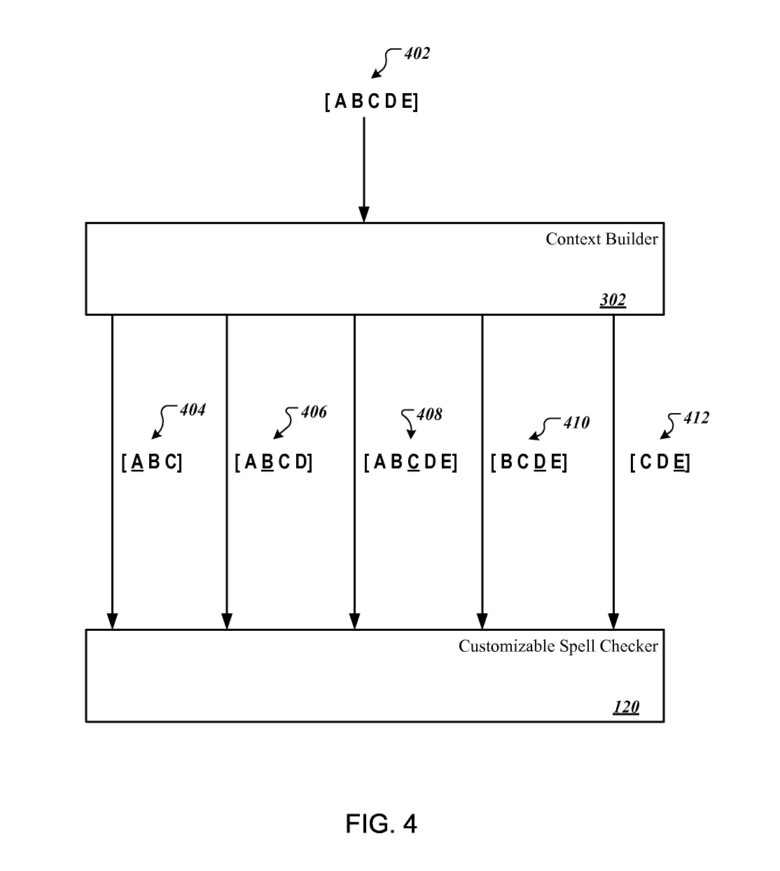

Upon receiving the term 110 and the optional text, if any, the SSCI 114 provides the term 110 and optional text to a customizable spell checker 120. The customizable spell checker 120 includes a spell checking program that is configured to spell check a term without context or a term in a context. The context of a term can be several terms before or after the term. A software component executing on the server 104 can divide long text into short segments, each short segment including a term to be spell checked and a context of that term. Further details on the techniques of dividing text into segments are described below in reference to FIG. 3 and FIG. 4.

The customizable spell checker 120 is configured to perform the spell check using a noisy channel model and a language model. A model builder 130 generates the noisy channel model and the language model used by the customizable spell checker 120.

The customizable spell checker 120 generates one or more spelling correction suggestions 116 for a term using the noisy channel model, the language model, and, if a context is provided, the context. Each of the spelling correction suggestions 116 can be associated with a confidence score. The server 104 then sends the one or more spelling correction suggestions 116, and associating confidence scores, if any, to the CSCI 112 of the user device 102 through the communication network 105. Upon receiving the one or more spelling correction suggestions 116, the user device 102 can display the one or more spelling correction suggestions 116 in the text editor 106, in proximity to the term 110.

The text editor 106 can display both spelling correction suggestions from the local spell checker 108 and spelling correction suggestions 116 from the server 104 in an integrated suggestion list. Accordingly, a possibly misspelled term can be spell-checked in both a prescriptive manner (by using the local dictionary of local spell checker 108) and in a descriptive manner (by using data reflecting current common usage captured by the language model builder 130).

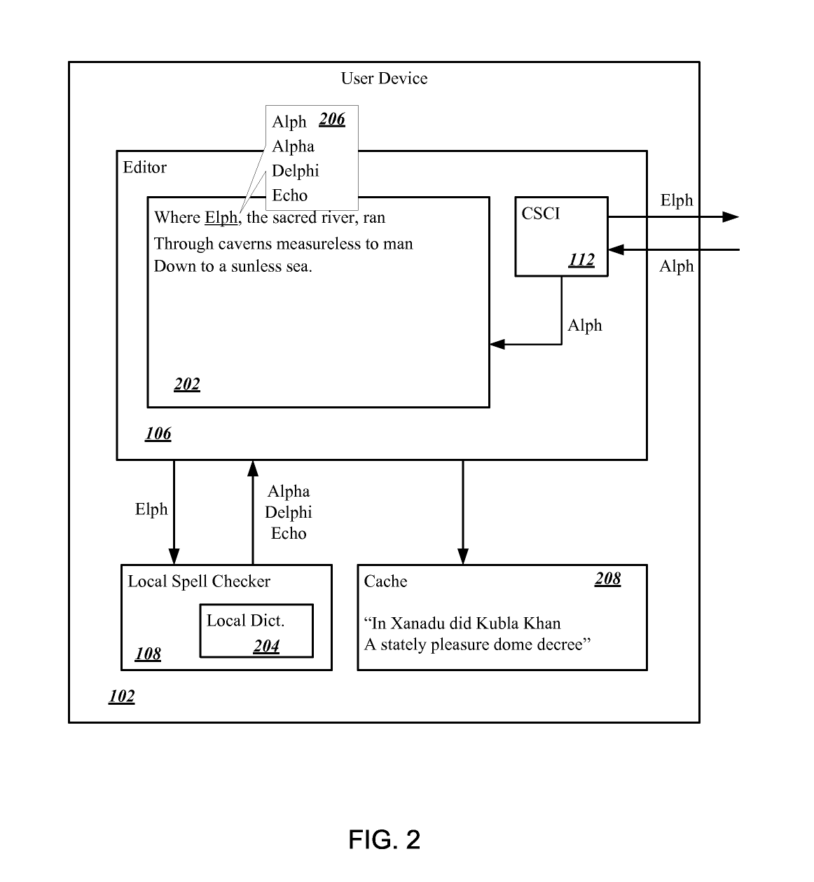

FIG. 2 is a block diagram illustrating an example user device 102 configured for server-based spell checking The user device 102 includes text editor 106. The text editor 106 is configured to provide for display a text editing area 202. The text editing area 202 can be a text box rendered by a web browser or a text editing window of a word processing program. The text editor 106 receives user input text, for example, “Where Elph, the sacred river, ran<cr>Through caverns measureless to man<cr>Down to a sunless sea.” The notation “<cr>” represents a line break character.

A local spell checker 108, automatically or upon receiving a user request to spell check the input text, performs a local spell check on the input text using a local dictionary 204. The local dictionary 204 can include a pre-determined collection of common misspelled terms and their correct spelling forms. The local spell checker 108 determines that a term in the input text, e.g., “Elph,” is not a correctly spelled term in the local dictionary 204. The local spell checker 108 determines, based on the local dictionary 204, one or more spelling correction suggestions for the received term. For example, the local spell checker 108 can determine that the spelling correction suggestions for the term “Elph” are terms “Alpha,” “Delphi,” or “Echo.” The local dictionary 204 provides an indication to the text editor 106 that a term (“Elph”) may be misspelled, and provides the spelling correction suggestions to the text editor 106. Based on the indication, the CSCI 112 of text editor 106 designates the term “Elph” as a candidate term for further spell checking by a server.

The CSCI 112 can operate in various modes. In some implementations, the CSCI 112 of text editor 106 can send the candidate term (e.g., “Elph”) alone to a remote spell checking server without additional text. In some implementations, the SCSI 112 of text editor 106 can send the candidate term to the remote spell checking server with additional text. In either case, the SCSI 112 of text editor 106 can send an identifier to the remote spell checking server identifying which term is the candidate term to be spell checked. In some implementations, the text editor 106 provides a block of text (e.g., all text in the text editing area 202) to the remote spell checking server, without identifying a candidate term. In these cases, each term in the block of text can be spell checked.

When the CSCI 112 identifies the candidate term to be spell checked, the CSCI 112 can send the candidate term to the spell checking server automatically or upon user request. In the former case, the CSCI 112 of the text editor 106 can send the candidate term (e.g., “Elph”) to the spell checking server upon receiving an indication from the local spell checker 108 that the term may be misspelled. In the latter case, the CSCI 112 can mark the term (e.g., using a pre-specified font type, style, or color) for user attention upon receiving an indication from the local spell checker 108 that the term may be misspelled. The CSCI 112 can make the term interactive, e.g., operable to receive a user input indicating a request for further spell check. The CSCI 112 provides the candidate term to the remote spell checking server for spell checking upon receiving the user input.

When the CSCI 112 of the text editor 106 sends additional text with the candidate term, the CSCI 112 can automatically select text from the text editing area 202. The CSCI 112 can select text around the candidate term within natural breaks (e.g., text “Where Elph”), an n term string that includes the candidate term (e.g., text “Where Elph, the sacred river,” when n=5), a line of text in which the term “Elph” is located (e.g., text “Where Elph, the sacred river, ran”), a full sentence, or all text currently in the text editing area 202.

The CSCI 112 provides text to the remote server and receives a spelling correction suggestion, for example, “Alph.” The spelling correction suggestion received from the remote server may not be a common term as stored in local dictionary 204; the term may be a term commonly used in the context of the additional text. The text editor 106 can combine the spelling correction suggestion received from the remote server with the terms received from the local spell checker 108 (“Alpha,” “Delphi,” and “Echo”) to form a combined list of spelling correction suggestions 206. The text editor 106 can provide the combined list of spelling correction suggestions 206 for display in the text editing area 202, in proximity to the candidate term for a user to select a term with which to replace the candidate term.

When the spelling correction suggestion received from the remote server is associated with a confidence score, relative positions of the spelling correction suggestion and the terms received from the local spell checker can be determined based on the confidence score. For example, if the confidence score satisfies a threshold, the spelling correction suggestion can be displayed at the top of the combined list.

In some implementations, the text editor 106 is configured to optimize the use of remote spell checking by using a local cache 208. The local cache 208 is a memory in which the text editor 106 stores a portion of the text being edited, or an index to a portion of the text being edited. The portion of the text being edited includes text that has already been remotely spell checked by the server. Accordingly, the text editor 106 can be configured to send only text outside of the local cache 208 to be remotely spell checked by the server, thus saving network bandwidth and server processing resources. After a section of text has been remotely spell checked, the text editor 106 can add the section or an index to the section to the local cache 208. Likewise, if a section of text stored or indexed in local cache 208 is further edited after being remotely spell checked, the text editor 106 can remove the section of text or the index from the local cache 208.

FIG. 3 is a block diagram illustrating an example server 104 for server-based spell checking The server 104 includes SSCI 114 configured to receive text from a user device for spell checking The text can include one or more terms. The text can be accompanied by an identifier indicating a specific term in the one or more terms to be spell checked.

The server 104 includes a context builder 302. The context builder 302 is a software component of the server 104 that is configured to communicate with the SSCI 114 and a customizable spell checker 120. The context builder 302 includes instructions configured to cause the server 104 to create a context for spell checking a term among the one or more terms received by the SSCI 114, and provide the term and context to the customizable spell checker 120 for spell checking.

In some implementations, the SSCI 114 receives text that includes multiple terms to be spell checked, and no identifier indicating which term to be spell checked. For example, the SSCI 114 can receive a sentence or a paragraph that includes multiple words. The context builder 302 can be configured to cause the customizable spell checker 120 to spell check each term in the text. The context build 302 can build a context for each of the terms. The context builder 302 divides the text into multiple segments, each segment including a term and a context of the term. The size of each segment can be optimized based on characteristics of the customizable spell checker 120. The context builder 302 can then send the segments to the customizable spell checker 120 for serial or parallel spell checking.

The customizable spell checker 120 is a spell checker optimized for performing spell checking on a text segment that includes no more than a pre-specified number of terms (e.g., ten terms). The customizable spell checker 120 can be a spell checker optimized for spell checking a large number of inputs each of which is short (e.g., fewer than 10 terms) using a noisy channel model and a language model. Examples of spell checkers that can be used as the customizable spell checker 120 include spell checkers based on technologies described in Cucerzan et al., Spelling Correction as an Iterative Process That Exploits the Collective Knowledge of Web Users, June 2004, and Ahmad et al., Learning a Spelling Error Model from Search Query Logs, November 2005.

A model builder 130 includes a system configured to generate a generic noisy channel model 304 and a generic language model 306 based on document data 308. Document data 308 can include data of multiple web documents, including user input text. The web document can include web pages, anonymized text submitted for spell check, or both. The model builder 130 can generate the noisy channel model and language model using a publicly available language model toolkit (e.g., RandLM or the CMU-Cambridge Statistical Language Modeling Toolkit). The model builder 130 can generate the generic noisy channel model 304 and generic language model 306 dynamically or repeatedly to capture new spellings and usage of terms.

In some implementations, the model builder 130 can build an overlay noisy channel model 310 over the generic noisy channel model 304, and an overlay language model 312 in addition to the generic language model 306, for use by the customizable spell checker 120. The model builder 130 can build the overlay noisy channel 310 and the overlay language model 312 using user data 314 that are specific to a user, when the user gives permission to use the user data 314 to spell check the user's text. The user information can include, for example, an identifier of a user using the user device that sent a term for spell checking The overlay noisy channel model 310 and the overlay language model 312 can be custom built for the user. The overlay noisy channel model 310 and the overlay language model 312 can reflect, for example, terms that the user frequently uses. Even though the terms are spelled correctly under circumstances specific to the user, these terms are often treated as misspelled by a generic spell checker.

When the customizable spell checker 120 receives one or more segments of text from context builder 302, the customizable spell checker 120 performs spell checking on a term in each of the one or more segments using the noisy channel model 304, overlay noisy channel model 310, general language model 306, and overlay language model 312. The customizable spell checker 120 can send results of spell checking for each segment to an assembler 316. The assembler 316 is a software component of the server 104. The assembler 316 is coupled with the customizable spell checker 120 and the SSCI 114. The assembler 316 is configured to assemble the results of spell checking for each segment into a response to a request for spell checking text from the user device.

The assembler 316 is additionally configured to determine correct capitalization of the assembled response. Determining the correct capitalization of the assembled response can include applying a generic truecasing language model 320 to the assembled result. The generic truecasing language model 320 can be a language model generated by the model builder 130 or generated by another mechanism based on document data 308. The generic truecasing language model 320 can include indicators of estimated likelihood of capitalization on text being correct. In some implementations, determining the correct capitalization of the assembled response can include applying an overlay truecasing language model 322 to the assembled result. The overlay truecasing language model 322 can be generated based on user data 314. By applying the overlay truecasing language model 322, the assembler 316 can determine the correct capitalization based on user-specific preference or habit. The assembler 316 can send the assembled and truecased response to the SSCI 114, which then provides the response to an application program of a user device.

FIG. 4 is a diagram illustrating example segmenting techniques of server-based spell checking A context builder 302 (in reference to FIG. 3) receives text 402 for spell checking The context builder 302 identifies one or more terms from the received text, and provides a context for each of the one or more terms. Each context includes not more than a pre-specified number of terms. The context builder 302 designates the identified term and the context as a segment of the text. The context builder 302 sends each segment to a customizable spell checker 120 for spell checking The pre-specified number can be configurable to optimize the performance of the customizable spell checker 120. For example, the pre-specified number can be four, such that the each segment includes no more than five terms. The customizable spell checker 120 performs spell checking on one term of the five terms.

If the received text includes a single term, the context builder 302 sends one segment to customizable spell checker 120 for spell checking The segment includes the single term to be spell checked and an empty context.

If the received text includes multiple terms and is associated with an identifier of a term, the context builder 302 can generate a segment that includes the identified term and a number of terms before and after the term, up to the pre-specified number or to a boundary. The boundary includes one or more signals in the text designated as separators. A boundary can be, for example, a beginning of a sentence, an end of sentence, a line break character, or a punctuation mark. The context of a term to be spell checked need not include a term across a boundary from the term to be spell checked.

If the received text includes multiple terms and is not associated with an identifier, the context builder 302 can identify each term in the text as a term to be spell checked. The context builder 302 can generate multiple segments. Each segment can include a term and a number of terms before and after the term, up to the pre-specified number or to a boundary. The context builder can generate the segments by applying a sliding window to the text. The sliding window can have a size corresponding to the pre-specified number. For example, if the number is four, the sliding window can have a size of five terms.

In this example, the text 402 is a sequence of, for example, five terms (e.g., A, B, C, D, and E). Each term is a group of one or more characters (e.g., alphabets). In some implementations, a term can be a punctuation mark or a boundary marker. Each term can be encoded in an encoding scheme that is different from an encoding scheme of another term. Each term can be in a language that is different from the language of another term. The text 402 can be associated with an identifier indicating which term in text 402 is to be spell checked. In the absence of the indicator, as in the case of the example of FIG. 4, each of the terms A, B, C, D, and E would be spell checked.

In the example shown in FIG. 4, the context builder 302 provides five segments of the text 402 to the customizable spell checker 120 for spell checking Each segment corresponds to a term in text 402. For example, a text segment 404 includes term A for spell checking, and terms B and C as context. A text segment 406 includes term B for spell checking, and terms A, C, and D as context. Text segments 408, 410, and 412 each includes term C, D, or E, respectively, for spell checking Each of the terms C, D, and E is accompanied by respective contexts.

The customizable spell checker 120 performs the spell check for each of the terms A, B, C, D, and E of the text 402. The customizable spell checker 120 can automatically detect a language of each term based on the encoding scheme of the term, or based on spelling of the term and the context. For example, when all the terms are encoded in American Standard Code for Information Interchange (ASCII) scheme, the customizable spell checker 120 can designate a term “bien” as possibly misspelled, when the term follows a context “I have.” The customizable spell checker 120 can designate the same term as correctly spelled, when the term follows a context “Je vais.”

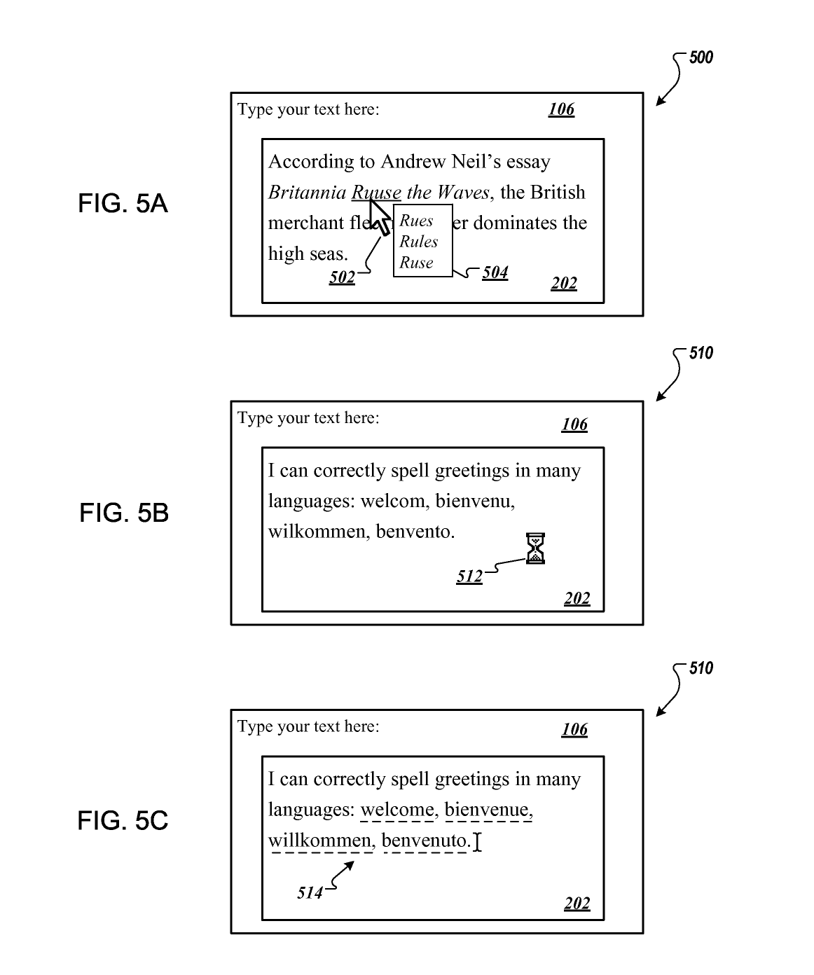

FIG. 5A-5C are illustrations of example user interfaces of user-side application programs for server-based spell checking. FIG. 5A illustrates an example user interface 500 provided in some implementations of server-based spell checking The user interface 500 displays, on a user device, a text editor 106 that includes a text editing area 202. A user device receives, from a user, an example text input in the text editing area 202. The text input can be a rich text string. The rich text string includes text and formatting information (e.g., font or color) of the text. In the example shown, the text is “According to Andrew Neil's essay Britannia Ruuse the Waves, the British merchant fleet no longer dominates the high seas.” Upon receiving the text input, the text editor 106 sends the string to a local spell checker, which can execute on the user device. The local spell checker determines that the term “Ruuse” may be misspelled. Based on similarity of the term “Ruuse” to words in a dictionary, the local spell checker mark the term “Ruuse” with a distinctive highlight, e.g., an underline or boldness. Other highlights are possible. The local spell checker can provide spelling correction suggestions “Rules” and “Ruse” which are popular words.

The text editor 106 receives a user input, which includes a selection of the highlighted term “Ruuse” by a cursor 502. Upon receiving the user input, the text editor 106 sends the term, as well as additional text, to a server for remote spell checking The text editor 106 receives a spelling correction suggestion “Rues,” which is determined by the server based on a context (e.g., “essay Britannia”). The text editor 106 can present the spelling correction suggestion “Rues” received from the server in addition to the local spelling correction suggestions “Rules” and “Ruse” in a suggestion box 504 as options. Upon receiving a user selection of a suggestion, the text editor 106 can replace the term “Ruuse” with the selected term.

FIG. 5B illustrates an example user interface 510 provided in some implementations of server-based spell checking The user interface 510 displays, on a user device, a text editor 106 that includes a text editing area 202. The text editor 106 receives input text, for example, “I can correctly spell greetings in many languages: welcom, bienvenu, wilkommen, benvento.” The text editor 106 can automatically send the input text to a server for remote spell checking Before receiving and response from the server, the text editor 106 can continue receiving user inputs. In some implementations, the text editor 106 can optionally display a timer 512 indicating that the text editor 106 is waiting for a server response.

FIG. 5C illustrates example user interface 510 when an application of a user device receives a response from a server. The response can include a text string 514 in which the server automatically replaces terms regarded as misspelled with spelling correction suggestions. The spelling correction suggestion for each replaced term can be in a language of the term replaced. The spelling correction suggestions can be marked (e.g., underlined) to indicate that these suggestions differ from the terms in the input text as entered by the user. The user interface 510 is operable to receive a user input on a marked spelling correction suggestion, and accept or reject the spelling correction suggestion based on the user input.

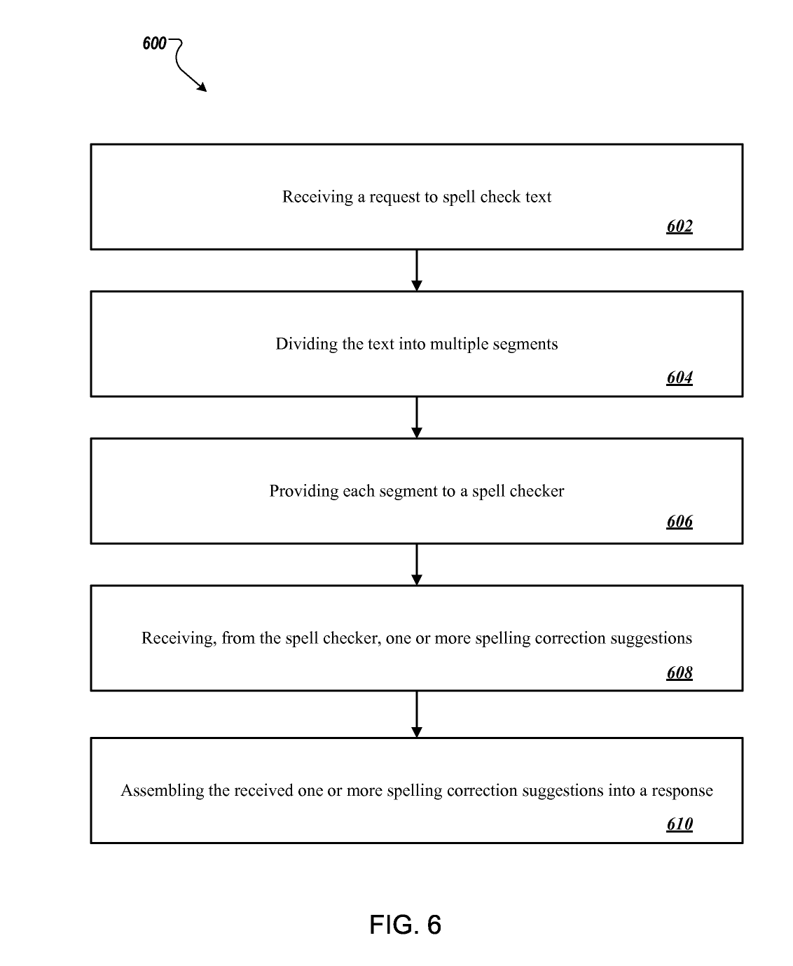

FIG. 6 is a flowchart illustrating an example process 600 performed by a software component of a server for server-based spell checking The server can include the server 104 as described above.

The software component of the server receives (602) a request to spell check text. The software component can receive the request from an application executing on a user device. The user device can include the user device 102 as described above.

The software component divides (604) the text into multiple segments. Each segment includes no more than a predetermined number of terms. Dividing the text can include dividing the text into one or more sentences, and dividing each sentence into one or more segments. A segment can partially or completely overlap with another segment. Additional details on operations of dividing the text into multiple segments are described above in reference to FIG. 4.

The software component provides (606) each of the segments to a spell checker. The spell checker is programmed to spell check an input including no more than the predetermined number of terms.

The software component receives (608), from the spell checker, one or more spelling correction suggestions. Each spelling correction suggestion corresponds to a term in a segment. The term is a term being designated as misspelled by the spell checker. In some implementations, the server can receive, from the spell checker, a dirty word indicator indicating the term includes a word that is a pornographic, obscene, or offensive word.

The software component can process a multilingual text string. When the text includes a first term in a first language and a second term in a second language, the software component can receive a first spelling correction suggestion for the first term and a second spelling correction suggestion for the second term. The first spelling correction suggestion can be in the first language. The second spelling correction suggestion can be in the second language.

The software component assembles (610) the received one or more spelling correction suggestions into a response to the request to spell check the text. The software component can send the response to the user device from which the request is received. The response to the request to spell correct the text can include a first spelling correction suggestion in a first language and a second spelling correction suggestion being in a second language. In some implementations, assembling the received one or more spelling correction suggestions includes truecasing the one or more spelling correction suggestions based on a truecasing language model. In some implementations, assembling the received one or more spelling correction suggestions into a response includes associating a dirty word indicator with the term in the response.

In some implementations, the process 600 can include generating a language model from a collection of documents, and configuring the spell checker using the language model. Generating the language model from a collection of documents can include generating a generic language model and generating an overlay language model. The server can generate the overlay language model using information specific to a user (e.g., the user's emails, blogs, and contact list). The server can collect the user specific information if the user provides consent to use personal information for spell checks. In some implementations, the process 600 can include generating a noisy channel model from a collection of documents and configuring the spell checker using the noisy channel model.

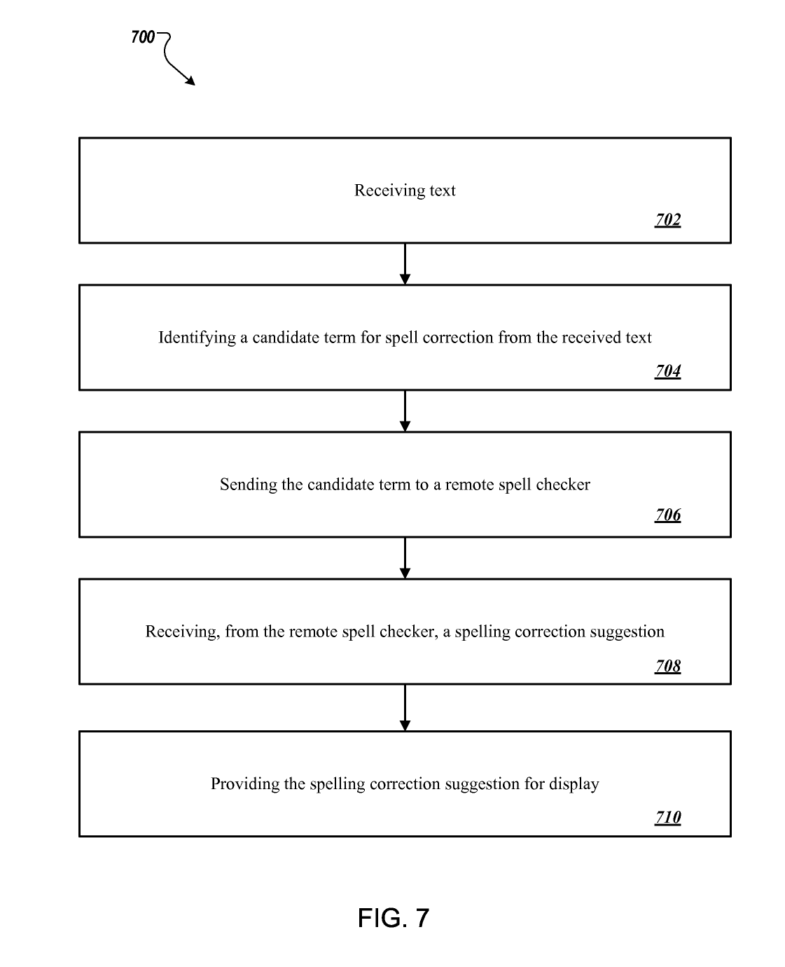

FIG. 7 is a flowchart illustrating an example process 700 performed by a software component of a user device for server-based spell checking The user device can include the user device 102 as described above.

The software component can receive (702) text. The text can be user input text. Receiving the text can include receiving the text in a text editing window of a browser executing on the user device.

The software component can identify (704) a candidate term for spelling checking from the received text. The candidate term includes a term designated as a misspelled term by a local spell checker. The local spell checker can be an application program executing on the user device.

The software component sends (706) the candidate term to a remote spell checker. The remote spell checker executes on a server that is connected to the user device through a communications network. The server can include server 104 as described above.

In some implementations, sending the candidate term to the remote spell checker can be done automatically when the local spell checker identifies the candidate term. In some implementations, sending the candidate term to the remote spell checker can be done upon receiving a user input. The user device can provide for display an indicator indicating that the candidate term is designated as a misspelled term. The indicator can be an interactive user interface element configured to receive a user input selecting the candidate term. The user device can receive, through the interactive user interface element, a user input selecting the candidate term. The user device can then send the selected candidate term to the remote spell checker in response to the user input.

In some implementations, the software component can send all text in the text editing window to the remote spell checker as addition information for spell checking the candidate term. In some implementations, the software component can send a neighboring term to the remote spell checker as addition information of the candidate term to the remote spell checker as addition information for spell checking the candidate term. The neighboring term can be a term located within a pre-specified threshold distance to the candidate term in the text. The distance can be a distance measured in number of terms. In some implementations, the user device can from the text a sentence in which the candidate term appears, and send the sentence to the remote spell checker as addition information for spell checking the candidate term.

The software component receives (708), from the remote spell checker, a response. The response includes a spelling correction suggestion for the candidate term. In some implementations, the response can include a dirty word indicator indicating that the candidate term may include a pornographic, obscene, or offensive word.

The software component provides (710) the spelling correction suggestion for display on the user device. For example, the spelling correction suggestion can be displayed at a location proximate to (e.g., next to or at least partially overlapping) a location of the candidate term in the text editing window from which the text is received. Providing the spelling correction suggestion for display can include providing the spelling correction suggestion in a rich text format such that the spelling correction suggestion is interactive.

In some implementations, process 700 includes storing a state of the text. The state corresponds to a portion of the text, and indicates that the portion of the text has been spell checked by the remote spell checker. The user device can store, in a local storage device, the candidate term and the spelling correction suggestion. Additionally, if the remote spell checker associated a dirty word indicator with the candidate term, the user device can store in the local storage device the dirty word indicator. Identifying the candidate term can include determined that the term designated as a misspelled term is not stored in a local storage device that stores terms previous spelling checked and their corresponding spelling correction suggestions.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
at a user device, receiving text;
identifying a candidate term for spelling checking from the received text, the candidate term including a term designated as a misspelled term by a local spell checker, the local spell checker executing on the user device;
sending the candidate term to a remote spell checker, the remote spell checker executing on a server that is connected to the user device through a network;
receiving, from the remote spell checker, a spelling correction suggestion for the candidate term; and
providing the spelling correction suggestion for display on the user device.

2. The method of claim 1, wherein:
receiving the text comprises receiving the text in a text editing window of a web browser executing on the user device, and
providing the spelling correction suggestion for display comprises providing the spelling correction suggestion for display at a location proximate to a location of the candidate term in the text editing window.

3. The method of claim 1, comprising sending all text in a text editing window to the remote spell checker as addition information for spell checking the candidate term.

4. The method of claim 1, comprising sending a neighboring term to the remote spell checker as addition information for spell checking the candidate term, the neighboring term being a term located within a threshold distance to the candidate term in the text.

5. The method of claim 1, comprising:
identifying from the text a sentence in which the candidate term appears; and
sending the sentence to the remote spell checker as addition information for spell checking the candidate term.

6. The method of claim 1, wherein sending the candidate term to the remote spell checker comprises one of:
automatically sending the candidate term to the remote spell checker upon identifying the candidate term using the local spell checker; or
sending the candidate term to the remote spell checker upon receiving a user input.

7. The method of claim 1, wherein sending the candidate term to the remote spell checker comprises:
providing for display an indicator indicating that the candidate term is designated as a misspelled term, the indicator operable to receive a user input selecting the candidate term;
receiving a user input selecting the candidate term; and
sending the selected candidate term to the remote spell checker in response to the user input.

8. The method of claim 1, comprising:
storing a state of the text, the state corresponding to a portion of the text and indicating that the portion of the text has been spell checked by the remote spell checker.

9. The method of claim 1, comprising storing, in a local storage device, the candidate term, the spelling correction suggestion, and, if the remote spell checker associated a dirty word indicator with the candidate term, the dirty word indicator.

10. The method of claim 1, wherein identifying the candidate term comprises determined that the term designated as a misspelled term is not stored in a local storage device that stores terms previous spelling checked and their corresponding spelling correction suggestions.

11. The method of claim 1, wherein:
providing the spelling correction suggestion for display comprises providing the spelling correction suggestion as interactive text.

12. A computer program product configured to cause data processing apparatus to perform operations comprising:
at a user device, receiving text;
identifying a candidate term for spelling checking from the received text, the candidate term including a term designated as a misspelled term by a local spell checker, the local spell checker executing on the user device;
sending the candidate term to a remote spell checker, the remote spell checker executing on a server that is connected to the user device through a network;
receiving, from the remote spell checker, a spelling correction suggestion for the candidate term; and
providing the spelling correction suggestion for display on the user device.

13. The product of claim 12, wherein:
receiving the text comprises receiving the text in a text editing window of a web browser executing on the user device, and
providing the spelling correction suggestion for display comprises providing the spelling correction suggestion for display at a location proximate to a location of the candidate term in the text editing window.

14. The product of claim 12, the operations comprising sending all text in a text editing window to the remote spell checker as addition information for spell checking the candidate term.

15. The product of claim 12, the operations comprising sending a neighboring term to the remote spell checker as addition information for spell checking the candidate term, the neighboring term being a term located within a threshold distance to the candidate term in the text.

16. The product of claim 12, the operations comprising:
identifying from the text a sentence in which the candidate term appears; and
sending the sentence to the remote spell checker as addition information for spell checking the candidate term.

17. The product of claim 12, wherein sending the candidate term to the remote spell checker comprises one of:
automatically sending the candidate term to the remote spell checker upon identifying the candidate term using the local spell checker; or
sending the candidate term to the remote spell checker upon receiving a user input.

18. The product of claim 12, wherein sending the candidate term to the remote spell checker comprises:
providing for display an indicator indicating that the candidate term is designated as a misspelled term, the indicator operable to receive a user input selecting the candidate term;
receiving a user input selecting the candidate term; and
sending the selected candidate term to the remote spell checker in response to the user input.

19. The product of claim 12, the operations comprising:
storing a state of the text, the state corresponding to a portion of the text and indicating that the portion of the text has been spell checked by the remote spell checker.

20. The product of claim 12, the operations comprising storing, in a local storage device, the candidate term, the spelling correction suggestion, and, if the remote spell checker associated a dirty word indicator with the candidate term, the dirty word indicator.

21. The product of claim 12, wherein identifying the candidate term comprises determined that the term designated as a misspelled term is not stored in a local storage device that stores terms previous spelling checked and their corresponding spelling correction suggestions.

22. The product of claim 12, wherein:
providing the spelling correction suggestion for display comprises providing the spelling correction suggestion as interactive text.

23. A system comprising:
one or more computers configured to perform operations comprising:
at a user device, receiving text;
identifying a candidate term for spelling checking from the received text, the candidate term including a term designated as a misspelled term by a local spell checker, the local spell checker executing on the user device;
sending the candidate term to a remote spell checker, the remote spell checker executing on a server that is connected to the user device through a network;
receiving, from the remote spell checker, a spelling correction suggestion for the candidate term; and
providing the spelling correction suggestion for display on the user device.

24. The system of claim 23, wherein:
receiving the text comprises receiving the text in a text editing window of a web browser executing on the user device, and
providing the spelling correction suggestion for display comprises providing the spelling correction suggestion for display at a location proximate to a location of the candidate term in the text editing window.

25. The system of claim 23, the operations comprising sending all text in a text editing window to the remote spell checker as addition information for spell checking the candidate term.

26. The system of claim 23, the operations comprising sending a neighboring term to the remote spell checker as addition information for spell checking the candidate term, the neighboring term being a term located within a threshold distance to the candidate term in the text.

27. The system of claim 23, the operations comprising:
identifying from the text a sentence in which the candidate term appears; and
sending the sentence to the remote spell checker as addition information for spell checking the candidate term.

28. The system of claim 23, wherein sending the candidate term to the remote spell checker comprises one of:
automatically sending the candidate term to the remote spell checker upon identifying the candidate term using the local spell checker; or
sending the candidate term to the remote spell checker upon receiving a user input.

29. The system of claim 23, wherein sending the candidate term to the remote spell checker comprises:
providing for display an indicator indicating that the candidate term is designated as a misspelled term, the indicator operable to receive a user input selecting the candidate term;
receiving a user input selecting the candidate term; and
sending the selected candidate term to the remote spell checker in response to the user input.

30. The system of claim 23, the operations comprising:
storing a state of the text, the state corresponding to a portion of the text and indicating that the portion of the text has been spell checked by the remote spell checker.

31. The system of claim 23, the operations comprising storing, in a local storage device, the candidate term, the spelling correction suggestion, and, if the remote spell checker associated a dirty word indicator with the candidate term, the dirty word indicator.

32. The system of claim 23, wherein identifying the candidate term comprises determined that the term designated as a misspelled term is not stored in a local storage device that stores terms previous spelling checked and their corresponding spelling correction suggestions.

33. The system of claim 23, wherein:
providing the spelling correction suggestion for display comprises providing the spelling correction suggestion as interactive text.
